(19) United States
(12) Patent Application Publication
(10) Pub. No.: US 2006/0194920 A1
(43) Pub. Date: Aug. 31, 2006

(54) Thermally conductive adhesive composition and process for device attachment

(76) Inventors: Miguel Albert Capote, Carlsbad, CA (US); Alan Grieve, San Diego, CA (US)

Correspondence Address: NATH & ASSOCIATES, 112 South West Street, Alexandria, VA, 22314, US

(21) Appl. No.: 10/550,408

(22) PCT Filed: Mar. 30, 2004
(86) PCT No.: PCT/US04/09886

§ 371 Date: Sep. 23, 2005

Related U.S. Application Data
(60) Provisional application No. 60/458,944, filed on Apr. 1, 2003.

(51) Int. Cl. C08K 3/10; C08F 20/02

(52) U.S. Cl. 524/779; 524/832

(57) ABSTRACT

Thermally conductive, sinterable, adhesive compositions, free of fugitive solvents, that include a powder of a relatively high melting point metal or metal alloy, a powder of a relatively low melting point metal or metal alloy powder and a thermally curable adhesive flux composition that comprises (i) a polymerizable fluxing agent; (ii) an inerting agent to react with the fluxing agent at elevated temperature, rendering it inert. The fluxing agent preferably comprises a compound with formula RCOOH, wherein R comprises a moiety having one or more polymerizable carbon-carbon double bonds. Optionally, the inventive compositions also include (a) a diluent that is capable of polymerizing with the fluxing agent's polymerizable carbon-carbon double bonds; (b) free radical initiators; (c) a curable resin; and (d) crosslinking agents and accelerators. The compositions can be applied directly onto the surfaces of devices to be joined mechanically and/or electrically and are ideally suited for semiconductor die attachment. During heating, the fluxing agent promotes wetting of the high melting point powder by the molten low melting point powder, causing liquid phase sintering of the powders. The fluxing agent also promotes wetting of the metallizations on the die and substrate by the molten low melting point alloy, providing improved thermal conductivity. Simultaneously, the fluxing agent itself crosslinks to further mechanically bond the adherent surfaces. The absence of fugitive solvents creates a void-free bond.

### TECHNICAL FIELD OF THE INVENTION

The present invention relates to the use of conductive adhesives for fabrication of electronic assemblies. More specifically it relates to materials, methods and assemblies for the fabrication of electronics containing devices requiring thermal dissipation for cooling. The present invention also relates to adhesives for semiconductor die attachment that provide improved thermal dissipation.

### BACKGROUND OF THE INVENTION

For a thermally conductive adhesive composition to be useful in the manufacture of semiconductor devices, it must meet certain performance, reliability and manufacturing requirements dictated by the particular application. Such performance properties include strength of adhesion, coefficient of thermal expansion, flexibility, temperature stability, moisture resistance, electrical and thermal conductivity and the like. Thermal conductivity is of particular importance in the electronics industry. With the trend towards miniaturization coupled with higher operating frequencies, there are ever-increasing demands on engineers to remove heat from circuitry. The extraction of heat generated by components within a package is necessary to prevent those components from overheating. This is a larger problem for electronics containing high-power devices that can dissipate many watts of energy during normal operation.

In the prior art, die attachment adhesives generally comprised a silver flake or powder dispersed in a curable resin, such as an epoxy. However, such prior-art adhesives have thermal conductivities unsuitable for devices that dissipate large amounts of heat. Additionally, the prior art adhesives often have poor mechanical properties. Another disadvantage is that some prior art adhesives contain solvents to maintain low viscosity. During cure, such solvents have a propensity to form voids, requiring a long bake-out operation to drive off the solvent prior to cure. This adds time and cost to the overall cure process. Another shortcoming is that adhesives generally have unstable contact resistance after environmental aging. Heat and humidity also tends to reduce adhesion of conductive adhesives. Moisture absorption of conductive adhesives can lead to delamination failures during printed circuit assembly.

Few prior-art die attachment adhesives have the thermal conductivity suitable for use with high power devices. As a result, solder bonding is often the preferred method. Solders have the advantage of having many times the thermal conductivity of most die attachment adhesives. Solders also have the advantage of the solder forming intimate metallurgical bonds with the devices being soldered. A metallurgical interface provides superior heat transfer compared to the typical adhesive interface.

However, solder bonding has a number of disadvantages. Solder preforms are usually employed to dispense solder between devices to be bonded, which are more expensive to apply during production than adhesive pastes. In addition, many die attachment solders contain lead, which is not desirable due to environmental concerns. The best lead-free solders require very high process temperatures that are often damaging to the assemblies themselves. Another difficulty is that solder remelts if heated to an elevated temperature, yet elevated temperatures are required during electronic fabrication, e.g. during assembly of components to printed circuit boards. Such remelting of solder between components in a circuit can cause the parts to separate and subsequently fail.

Prior art related to adhesives is found in U.S. Pat. Nos. 6,613,123, 6,528,169, 6,238,599, 6,140,402, 6,132,646, 6,114,413, 6,017,634, 5,985,456, 5,985,043, 5,928,404, 5,830,389, 5,713,508, 5,488,082, 5,475,048, 5,376,403, 5,285,417, 5,136,365, 5,116,433, 5,062,896, and 5,043,102. Representative prior art directed to die attachment is found in U.S. Pat. Nos. 4,811,081, 4,906,596, 5,006,575, 5,250,600, 5,386,000, 5,399,907, 5,489,637, 5,973,052, 6,147,141, 6,242,513, and 6,351,340, and published PCT application WO 98/33645. The entire contents of all listed documents is hereby incorporated by reference.

There is clearly a need for a new composition that provides the best advantages of both solder and conductive adhesive. There is a need for a conductive adhesive that forms metallurgical bonds with the devices being bonded. There is also a need for an adhesive with significantly more thermal conductivity than is currently possible with silver powder-resin compositions while retaining high mechanical strength. There is a need for a bonding material that hardens when used so that it does not remelt at elevated temperatures. There is also a need for a bonding material that has high thermal conductivity yet can be dispensed in paste form, without solvents, rather than preforms. There is also a need for a bonding material that is lead-free. There is, furthermore, a need for a conductive adhesive that does not suffer delamination, reduced adhesion, or conductivity after aging, humidity exposure, etc.

### BRIEF SUMMARY OF THE INVENTION

The present inventive subject matter relates to a thermally conductive adhesive composition devoid of fugitive solvents comprising:
a) a powder of a high melting point metal or metal alloy;
b) a powder of a low melting point metal or metal alloy; and
c) a thermally curable adhesive flux composition that is comprised of:
   (i) a polymerizable fluxing agent represented by the formula RCOOH wherein R comprises a moiety having one or more polymerizable carbon-carbon double bonds; and
   (ii) an inerting agent to react with the polymerizable fluxing agent at elevated temperature, rendering the polymerizable fluxing agent inert.

The present inventive subject matter is also drawn to an electronic assembly comprising an electronic device and a substrate bonded by a sintered thermally conductive adhesive, said adhesive devoid of fugitive solvents and comprising:
a) a powder of a high melting point metal or metal alloy;
b) a powder of a low melting point metal or metal alloy; and
c) a thermally curable adhesive flux composition that is comprised of:
   (i) a polymerizable fluxing agent;
   (ii) an inerting agent to react with the fluxing agent at elevated temperature, rendering the polymerizable fluxing agent inert.

In a preferred embodiment, the thermally conductive adhesive composition further comprises one or more components selected from the group consisting of: (a) a diluent that is capable of polymerizing with the fluxing agent's polymerizable carbon-carbon double bonds; (b) a source of free radical initiators; (c) a curable resin; (d) a crosslinking agent that improves crosslinking of the curable resins or fluxing agents; and (e) an accelerator to increase the rate of reaction.

Furthermore, the present inventive subject matter is directed to a method of attaching an electronic device to a substrate comprising the steps of:
(a) obtaining an electronic device with at least one bondable surface;
(b) obtaining a substrate with a corresponding bondable surface;
(c) dispensing a thermally conductive adhesive on one or both of the bondable surfaces of the substrate or electronic device, said adhesive devoid of fugitive solvents and comprising:
   (i) a powder of a high melting point metal or metal alloy;
   (ii) a powder of a low melting point metal or metal alloy; and
   (iii) a thermally curable adhesive flux composition that is comprised of:
      (A) a polymerizable fluxing agent;
      (B) an inerting agent to react with the fluxing agent at elevated temperature, rendering the polymerizable fluxing agent inert;
(d) placing the electronic device on the substrate so the bondable surface of the electronic device is mated with the bonding surface of the substrate, thereby forming a combined assembly;
(e) heating the combined assembly to an elevated temperature, thereby causing the powder of the low melting point metal or metal alloy to liquefy;
(f) allowing the liquefied low melting point metal or metal alloy to sinter with the high melting point metal or metal alloy and the inerting agent to react with the fluxing agent, rendering the fluxing agent inert;
(g) polymerizing the fluxing agent; and
(h) allowing the assembly to cool.

### DETAILED DESCRIPTION OF THE INVENTION

Unlike the prior art, the adhesives of the present invention form metallurgical bonds to devices and substrates. In this sense, the adhesives bond similarly to prior-art solders used in die-attachment. However, unlike the solders of the prior art, the inventive adhesives comprise pastes that, when heated, first melt, then harden. Thereafter the adhesives do not remelt if they are elevated to the temperature at which they first melted. The invention addresses many of the shortcomings of prior art solders and adhesives, providing an easily-processed, solvent-free adhesive capable of forming metallurgical joints similar to solder. The inventive compositions have the further advantage they may be used as a replacement for solder paste during surface mount (SMT) manufacturing. The invention further comprises an electronic assembly employing inventive adhesive compositions for improved thermal dissipation.

The compositions of the present invention are free of fugitive solvents and comprise
a) a powder of a relatively high melting point metal or metal alloy;
b) a powder of a relatively low melting point metal or metal alloy; and
c) a thermally curable adhesive flux composition that comprises:
   (i) a polymerizable fluxing agent;
   (ii) an inerting agent to react with the fluxing agent at elevated temperature, rendering the polymerizable fluxing agent inert.

The thermally curable adhesive flux composition optionally comprises these additional components:
(i) a fluxing agent represented by the formula RCOOH wherein R comprises a moiety having one or more polymerizable carbon-carbon double bonds;
(ii) a diluent that is capable of polymerizing with the fluxing agent's polymerizable carbon-carbon double bonds;
(iii) a source of free radical initiators;
(iv) a curable resin;
(v) crosslinking agents that improve crossinking of the curable resins or fluxing agents;
(vi) an accelerator to increase the rate of these reactions.

Sintering and curing of the inventive compositions is achieved by heating. When compositions are heated to the liquidus or melting point of the low melting point component, the composition forms a transient liquid phase. Unlike the prior art taught by U.S. Pat. No. 6,613,123, the included thermally curable adhesive flux composition serves initially as a fluxing agent, facilitating the removal of oxides from the surfaces of the metal powders and also facilitating wetting of metallic surfaces by the molten metals. As the heating process is continued, the liquid phase and the high melting point metals react and isothermally solidify through a process known in the art as liquid-phase sintering. The heating process also serves to neutralize the fluxing components in the resin so that the components become non-corrosive and chemically stable. Unlike prior art compositions, such as described in U.S. Pat. No. 5,376,403, this may occur before, during or after the sintering of the metals. After the sintering process occurs, the heat causes the thermally curable adhesive flux composition to polymerize, forming a hard intractable binder. Heating is done by either continuous reflow processes commonly used in soldering or by using simple isothermal processing methods.

Preferably, the primary inventive fluxing agent in these compositions integrate within a single molecule carboxylic acid groups that provide the fluxing action for the soldering process without need of corrosive ions or halogens, and polymerizable carbon-carbon double bonds that can polymerize upon application of heat, to form a high-strength solid adhesive polymer. This is accomplished without generating gases, water, or other harmful by-products. An inerting or neutralizing agent is included to react during heating with the flux acid groups and any flux residues. As a consequence, after the thermally curable adhesive composition is cured, the flux residues do not need to be washed away or removed since they are inert and non-corrosive.

Solvents are not required as the thermally curable adhesive flux composition itself can comprise a relatively low-viscosity liquid. By incorporating low-viscosity fluxing agents, resins and diluents, the thermally curable adhesive flux composition has sufficiently low viscosity to permit the incorporation of very high levels of conductive filler powders without the need to add solvents.

Adhesive compositions involving transient liquid phase sintering in the presence of a polymerizing flux are known in the prior art, for example U.S. Pat. No. 5,376,403. Hovever, the prior art has been principally directed at electrically conductive adhesives with high electrical conductivity, e.g. electrically conductive traces for printed circuits, where creation of microvoids during curing is generally harmless. The use of such adhesives in high thermal conductivity applications, such as silicon die attachment, had been previously stymied by the microvoids created in the adhesives of the prior art during the curing process. Voids cause the bonds formed to weaken. Voids also reduce the thermal conductivity of the bonds.

The inventors discovered that the voids are due to fugitive solvents in the adhesives of the prior art, e.g. butyl carbitol (see examples 1-16 of U.S. Pat. No. 5,376,403), which cannot completely bake out during curing. These fugitive solvents have been required in the prior art in order to make the prior art compositions completely sinter. However, in the instant invention, it has been possible for the first time to produce transient liquid phase sintered adhesives without fugitive solvents. It was found that elimination of the fugitive solvents produces bonds that are void-free. Thus, a practical method for bonding two parts by means of transient liquid phase sintered adhesives to achieve improved thermal conductivity through the bond has been achieved for the first time.

1. Fluxing Agents

Fluxing agents normally comprise carboxylic acid moieties or precursors of such moieties. The preferred flux comprises carboxylic acid moieties. The most preferred fluxing agent has the structure RCOOH, wherein R comprises a moiety which include a readily polymerizable carbon-carbon double bond, where R does not provide chemical protection to the fluxing group COOH. The fluxing agents of the, present invention exhibit flux activities that are superior to that of prior art, polymer-fluxing agent mixtures. Since the inventive fluxing agents are intrinsically self-crosslinking, the thermally curable adhesive composition does not require the use of epoxy resins for crosslinking, although the epoxy resins may be added for neutralization of the acid.

Also, the adhesion, mechanical integrity, and corrosion resistance achieved with the preferred fluxing agents are superior to those achieved with some prior art polymer fluxing agents because there is no need to add aggressive fluxing activators. The inventive fluxing agents can be fully crosslinked and all components chemically immobilized upon curing. Even the reaction by-products of flux deoxidization of the metals are chemically bound in the polymer matrix.

Carboxylic acids function well as fluxing agents to remove oxides from metals. In addition, carboxylic acids are also very effective crosslinking moieties when present in their reactive form in a fluxing composition containing a suitable thermosetting resin, such as an epoxy. For this reason, in the prior art, chemical protection of the carboxylic acid was essential to achieving stability and preventing premature reactions, as described in U.S. Pat. No. 5,376,403. Protection was achieved by binding the fluxing agent with a chemically- or thermally-triggered species so that it becomes reactive only at or near the time that the solder melts. However, with the preferred fluxing agents of the instant invention, no such protection is necessary because the compositions do not cure significantly until the elevated temperature required for sintering is reached or exceeded. This results in a fluxing agent that can function at its full strength with the metal oxides to produce fluxing that is superior to any heretofore polymerizable fluxing agent. For die attachment adhesive applications, this allows the adhesive composition to produce sound and complete metallurgical bonds with the metallizations on the die and substrate before hardening. This leads to superior thermal conductivity through the bonds, not possible in the prior art.

With the preferred fluxing agent, the principal polymerization occurs at the carbon-carbon double bonds existing in the fluxing agent molecule, not at the carboxylic acid moiety. This is a distinct advantage over the prior art, wherein the polymerization occurs at the carboxylic acid moiety. The carboxylic acid of the inventive flux does not polymerize with the carbon-carbon double bonds. Therefore, on its own, in the absence of other components that can react with the carboxylic acid, the inventive fluxing agent does not oligomerize or polymerize at ambient temperatures. It is only at elevated temperatures that the double bonds begin to open and react with other double bonds to crosslink. Thus, premature polymerization, which is typical of the prior art, does not occur in the inventive flux. The result is that the inventive flux requires no chemical protection, as in the prior art. Therefore, the flux activity can be kept very high without concern about pre-maturely crosslinking the flux.

A preferred embodiment of the most preferred fluxing agent has an acrylic or methacrylic moiety that is incorporated into the fluxing agent molecule itself. For its low viscosity and high flux activity, a particularly preferred acrylic containing fluxing agent is 2-(methacryloyloxy)ethyl succinate which is described in Example 1. Other preferred fluxing agents include mono-2-(methacryloyloxy)ethyl maleate, mono-2-(methacryloyloxy)ethyl phthalate and mono-2-(acryloyloxy)ethyl succinate. Fluxing agents of this type typically are liquid at ambient temperatures (about 23-25 ° C.). Therefore, no solvent is required. The use of low viscosity fluxing agents is preferred in the present invention to permit the loading of high concentrations of conductive metal powders into the adhesive compositions without the needed for added fugitive solvents.

2. Inerting Agents

An inerting or neutralizing agent is added to the inventive compositions to react with carboxylic acid present in the mixture after the fluxing action is completed, thereby eliminating the need for additional cleaning to remove potentially corrosive residues. Epoxides are particularly suitable for this purpose, though others, such as cyanate esters, can also neutralize the carboxylic acid function. The reaction between epoxides and carboxylic acids is well known to those skilled in the art. To ensure complete neutralization, a stoichiometric equivalent or excess of non-fluxing epoxide must be present. The inerting agent is preferably miscible with the fluxing agent and with other components in the composition. It can be mono-functional or multi functional, liquid or solid. Non-limiting examples of preferred inerting agents include one or more components selected from the group consisting of bisphenol A diglycidyl ether, bisphenol F diglycidyl ether, 1,4-cyclohexanedimethanol diglycidyl ether, 3,4-epoxycyclohexylmethyl 3,4-epoxycyclohexanecarboxylate, N,N-diglycidyl-4-glycidyl-oxyaniline, glycidyl phenyl ether, glycidyl 4-methoxyphenyl ether, epoxy propyl benzene and mixtures thereof. These are all commercially available.

The inerting agent concentration in the inventive flux should be stoichiometric, or somewhat in excess of stoichiometric, with the carboxylic acid component in order to inert all of the acid during curing of the inventive conductive adhesives. Too high a concentration of inerting agent may cause excessive polymerization, which will limit sintering of the metals, whereas too low a concentration may leave unreacted pendant acid groups after cure, which are corrosive.

3. Resins

The thermally curable fluxing composition does not typically require additional non-fluxing or non-diluent resins. Compositions that do not include resins often have longer pot lives and lower viscosities during solder reflow. As a result, inclusion of a resin in the composition is not preferred, except as an inerting agent. The resins, however, can also function to increase the adhesion of the cured composition to the substrate and to increase the cohesive strength and glass transition temperature of the cured composition. Thus, as an option, a resin can be employed so long as concentrations are kept relatively low. The resin may be any suitable resin that is blendable with the fluxing agent. By blendable is meant that the resins do not have to be chemically bonded to the fluxing agent and/or diluent. Preferred resins, though, can react with the carboxylic acid groups in the fluxing agent, inerting them, or by other reactive moieties, such as optional —OH groups, in the diluent. If too large a concentration of resin is present, the polymerization of the inventive flux is driven by the resin rather than by the carbon-carbon double bonds. Since such polymerization typically occurs at lower temperature than double-bond addition, it leads to the flux hardening prematurely, which impedes sintering of the metals in the adhesive paste.

Non-limiting examples of resins that meet these requirements include materials selected from the group consisting of epoxies, phenolics, novalacs (both phenolic and cresolic), polyurethanes, polyimides, bismaleimides, maleimides, cyanate esters, polyvinyl alcohols, polyesters, and polyureas. Preferred resins include materials selected from the group consisting of bisphenol A diglycidyl ether, bisphenol F diglycidyl ether, 1,4-cyclohexanedimethanol diglycidyl ether, 3,4-epoxycyclohexylmethyl 3,4-epoxycyclohexanecarboxylate, N,N-diglycidyl-4-glycidyl-oxyaniline, and mixtures thereof. These are commercially available.

It is also beneficial to include crosslinking agents when resins are used in the inventive compositions. Crosslinking agents are well established in the prior art. Examples of crosslinking agents include anhydrides and carboxyl-functionalized polyesters. The addition of such materials facilitates the crosslinking reaction of the resin. Examples of suitable anhydride crosslinking agents include one or more components selected from the group consisting of, but not limited to tetrahydroplithalic anhydride, hexahydro phthalic anhydride, nadic methyl anhydride, 4-methythexahydrophthalic anhydride, and methyltetrahydrophthalic anhydride. All are commercially available.

When crosslinking agents are used, it is also useful to add an accelerator to increase the rate of crosslinking during thermal cure. Examples of suitable accelerators include imidazole and its derivatives, dicyandiamide and biguanide derivatives as well as tertiary amines such as benzyldimethylamine or 1,8-diazacyclo[5.4.0]undec-7-ene. Alternatively, transition metal acetylacetonates may also be used to accelerate the rate of reaction during thermal cure between epoxide resins and anhydride crosslinking agents. Non-limiting examples include one or more components selected from the group consisting of copper (II) acetylacetonate, cobalt (III) acetylacetonate and manganese (II) acetylacetonate.

4. Diluents

The presence of carbon-carbon double bond(s) in the fluxing agent molecule allows significant flexibility in the formulation of a flux composition with improved thermomechanical properties. This is achieved by the addition of double bond containing diluents that also crosslink with the flux to create a superior adhesive. This technique permits the design of fluxing adhesive compositions that attain high crosslink densities, which are desirable for good thermomechanical properties and good adhesion. Moreover, this is accomplished without the concern of premature crosslinking and reduced pot life associated with the prior art. Non-limiting examples of preferred diluents include one or more components selected from the group consisting of 1,6-Hexanediol Diacrylate, 1,6-Hexanediol Dimethacrylate, tris[2-(acryloxy)ethyl]isocyanurate, Trimethylolpropane Trimethacrylate, Ethoxylated Bisphenol Diacrylate and mixtures thereof. Most di and tri-functionalized acrylate resins with low viscosity, well known to those skilled in the art, are suitable for this purpose Other double bond containing compounds, many of which are commercially available, including, for example, diallyl phthalate and divinyl benzene can also be used. Hydrophobic diluents as described are preferred but hydrophilic diluents can also be employed when appropriate.

One benefit of employing hydrophobic diluents is that their presence tends to reduce the amount of water that the cured adhesive composition will absorb. The reason is that the fluxing agent, when crosslinked, will have active carboxylic groups that can attract water, even though these carboxylic groups, being part of a network, are immobile. Water acts as a plasticizer, which softens the cured adhesive composition. The use of hydrophobic diluents that are crosslinked to the fluxing agent will counteract the hydrophilic effects of the carboxylic acid groups.

5. Free Radical Initiators

While the thermally curable adhesive composition can be cured using heat alone, the cross linking reaction can be initiated and facilitated by the presence of free-radicals, including, for example, those generated by preferred initiators such as benzoyl peroxide, cumyl peroxide, 1,1′-azobis(cyclohexanecarbonitrile), 2,2′-azobisisobutyronitrile, and mixtures thereof. These free radical initiators or sources are commercially available. In the presence of certain metals, such as copper, premature decomposition of peroxy initiators may occur due to unfavorable redox reactions resulting in outgassing and voids in the cured composition. Therefore, in a preferred embodiment, azo-type initiators are used.

Free-radicals are created in-situ by exposure of the free-radical initiator to heat, radiation, or other conventional energizing sources. Introduction of an appropriate free-radical initiator accelerates the onset of crosslinking to the desired moment in a solder reflow or isothermal curing operation. The presence of a small amount of free-radical crosslinking initiator in the fluxing agent is used to control the rate and the temperature of crosslinking of the fluxing agent, ensuring effective fluxing action and strong adhesion of the composition to the substrates upon curing.

Thermally Curable Adhesive Flux Composition Relative Concentrations

In preparing the thermally curable adhesive flux composition, the proportions of each of the components may be varied over a considerable range and still yield acceptable fluxing activity as well as good post cured material properties. Preferably, the thermally curable adhesive flux composition employed does not produce gaseous byproducts that result in the formation of bubbles in the final cured composition. This is achieved with thermally curable compositions formulated as follows:
a) Fluxing agent comprising about 15%-65% (wt) of the thermally curable adhesive flux composition;
b) Inerting agent comprising about 10%-55% (wt) of the thermally curable adhesive flux composition;
c) Diluent comprising about 0%-75% (wt) of the thermally curable adhesive flux composition;
d) Free radical initiator comprising about 0%-2% (wt) of the thermally curable adhesive flux composition, preferably between about 0%-0.7%, and more preferably about 0.03%-0.4% by weight of the thermally curable adhesive composition;
e) Resin comprising about 0%-60% (wt) of the thermally curable adhesive flux composition;
f) Crosslinking agents comprising 0%-75% (wt) of the thermally curable adhesive flux composition; and
g) Accelerators comprising 0-1% of the thermally curable adhesive flux composition.

Some of the thermally curable fluxing compositions within these ranges may exhibit undesirably high moisture absorption, low glass transition temperatures, or high coefficients of thermal expansions after cured, but even those compositions remain useful as fluxing compositions in adhesive compositions where these characteristics are not critical.

Most preferably, the thermally curable polymeric fluxing composition after being cured has a glass transition temperature in excess of 100° C., relatively low coefficient of thermal expansion (100 ppm/° C. or less) and moisture uptake of less than 3%. While, again, some of the fluxing agents within these ranges exhibit high coefficient of thermal expansion or low glass transition temperature when cured, the compositions remain useful as fluxing resins in applications where these characteristics are not critical.

Metal Powders

The inventive adhesive compositions comprise a blend of high melting point and low melting point metal or alloy powders. The preferred powders comprise round particles or flakes. The methods of preparation of metal flake are well known to those skilled in the art. The metal powders should comprise a range of sizes to improve packing density. In the preferred adhesive compositions, the round particles have a maximum size of about 100 microns and, more preferably, are less than about 50 microns in size. Flakes may range from about 1 to about 50 microns in size. The use of flakes below about 30 microns is preferred to prevent the texture of the adhesive composition from becoming too coarse. Though it is well known that oxide removal from fine metal powders is more difficult due to the higher surface area, the fluxing activity of the inventive compositions are sufficiently high to provide satisfactory oxide removal.

Any solderable or alloyable metal, alloy or metal mixture is usable as the high melting point powder. Preferably, the high melting point metal powder is a material selected from the group consisting of copper, silver, aluminum, nickel, gold, platinum, palladium, beryllium, rhodium, nickel, cobalt, iron, molybdenum and alloys or mixtures thereof. The most preferred high melting point metals are copper, silver, nickel and gold. When spherical powders are used, it is preferred that the powders have smooth, even morphology, as is typically produced using gas atomization methods. Most desirably, the high melting point powder is comprised of a mixture of spherical powder and flake. The use of spherical powders permits a high metal loading in the adhesive composition, which is desirable for high thermal and electrical conductivity, while the addition of flake helps improve the rheology of the adhesive and facilitates application or dispensing using conventional equipment used in the fabrication of electronic assemblies. It also serves to prevent settling of the filler particles in the resin, maintaining the homogeneous nature of the material eliminating the need to re-mix the material prior to use. The high melting point powder comprises from about 10-90% by weight of the total powder composition, though more preferably about 40-70% by weight of the total powder composition.

Any solderable or alloyable metal, alloy or metal mixture is usable as the low melting point metal so long as it has a melting point well below that of the high melting point powder. The melting point is preferably about 50° C. or more below the melting point of the high melting point powder. More preferably, the melting point is about 100° C. or more below the melting point of the high melting point powder. Preferably, the low melting point metal powder comprises one or more elements selected from the group consisting of Sn, Bi, Pb, Cd, Zn, In, Te, Tl, Sb, Se and alloys, or mixtures thereof. However, in a preferred embodiment of the current invention, the low melting point powder is comprised of a commercial solder powder prepared from a combination of the metals listed. It is also preferred that the low melting point powder have a liquidus temperature below 200° C. such that it melts prior to the hardening or curing of the polymeric fluxing agent. Most preferably, the low melting point alloy is lead-free. Typically, the solder powders used have particles sizes from about 1 to about 100 microns. Most commonly, the solder powder consists of a type 3 (25-45 microns) size distribution or higher. The low melting point powder comprises from about 10-90% by weight of the adhesive powder mixture, though more preferably about 30-50% by weight of the total powder composition. When high levels of low melting point alloy are used, a large concentration may remain unsintered after cure.

Preparation of the Adhesive Compositions

In the preparation of the conductive adhesive composition, the low and high melting point metal powders are first blended to ensure a homogeneous mixture. With the preferred metal powders, the blending is performed in air at room temperature. Blending of the powders in an inert gas, such as nitrogen, is also possible to reduce the oxidation. Suitable methods of powder blending, such as shell blending, are well known to those skilled in the art.

To this powder mixture is added the thermally curable adhesive flux composition. High shear mixing is necessary to ensure homogeneity in the resulting paste. A method of high-shear blending known in the art is double planetary mixing. The concentration of metal powder in the final adhesive preferably ranges from about 80-93% by weight, but more preferably 85-92% by weight of the total adhesive composition. The remainder of the adhesive composition, preferably about 7-20% by weight, but more preferably about 8-15% by weight, is comprised of the thermally curable adhesive flux composition. These adhesive compositions are generally paste-like and are typically suitable for dispensing through a syringe using commercial dispensing equipment without the need for added solvent. Alternatively, the adhesive compositions are be suitable for application by stencil or screen printing techniques, well known to those skilled in the art.

Die Attachment

Though the thermally-curable adhesive compositions of the present invention have many uses, the adhesives are particularly well suited for attaching semiconductor die to substrates. In particular, the high thermal conductivity of the adhesives makes them well suited for bonding of semiconductor power devices to substrates. It is preferred that both the substrate and the die be metallized to allow the solder or low-melting point alloy to form metallurgical bonds. Such metallurgical bonds provide high strength and superior thermal and electrical conductivity.

In the prior art, semiconductor power devices are commonly bonded using solder. However, since the alloys employed in the preferred inventive compositions have lower melting points than prior-art die attachment solders, an advantage of the inventive compositions is that metallurgical bond formation can occur at lower temperatures. Furthermore, the transient liquid phase sintering that occurs during heating results in high melting point alloys that melt at temperatures well above the original curing temperature. This advantage over prior art solders provides additional latitude in the temperatures used to perform subsequent electronic assembly. The heat applied during the transient liquid phase sintering operation also cures the polymer flux, forming a secondary high strength bond.

The thermally curable adhesive compositions of the present invention are also suitable for attaching semiconductor die to a substrate in situations where the die, the substrate or both have no metallization. In these instances, solder die attachment is not possible. Adhesion of the die to the substrate is then due solely to the bonds formed by the polymeric component of the inventive adhesive, as is the case with prior art die attachment adhesives comprising a silver flake or powder dispersed in a curable resin. In these instances of the inventive die attachment processes, sintering occurs in the bulk of the inventive adhesive, but no metallurgical bond formation occurs at the interfaces of the surfaces being joined. The efficiency of heat transfer through these interfaces is now reduced compared to metallized surfaces.

However, in these instances, the sintering that occurs in the bulk of the adhesive provides higher stability and thermal conductivity than typically found prior art die attachment adhesives. Prior art adhesives rely on point-to-point contact of the filler particles to provide thermal and electrical conductivity. With age, this point-to-point contact undergoes degradation, resulting in reduced thermal and electrical properties. Such degradation does not occur in the inventive compositions since the filler particles are effectively sintered together.

Method of Bonding

A method of attaching an electronic device to a substrate comprises the steps of: obtaining an electronic device, such as a silicon die, with at least one bondable surface; obtaining a substrate with a corresponding bondable surface; dispensing the inventive thermally conductive adhesive on one or both of the bondable surface(s) of the substrate or electronic device; placing the electronic device on the substrate so the two bondable surfaces are mated, thereby forming a combined assembly; heating the combined assembly to an elevated temperature, causing the powder of the relatively low melting point metal or metal alloy to liquefy; allowing the liquefied low melting point metal or metal alloy to sinter with the relatively high melting point metal or metal alloy and the inerting agent to react with the fluxing agent, rendering the fluxing agent inert; polymerizing the fluxing agent; and allowing the assembly to cool.

A small amount of the inventive adhesive is applied to the desired bonding area on the substrate or die using conventional syringe dispensing equipment, known to those skilled in the art. The adhesive is dispensed as a small dot or in any pattern. Alternately, the adhesive is stencil printed onto the parts using stencil printing equipment known in the art. Sufficient material is dispensed to ensure the formation of a small fillet of material around the edge of the die after placement. Using conventional die placement equipment, the die is then placed on the bonding area and pressed with sufficient force to ensure complete coverage of the underside of the die with the adhesive. The assembly is then heated in an oven. An isothermal oven may be used, but preferably, a multizone solder reflow oven, known in the art, is employed. In either case, for sintering to occur, the assembly must reach the melt or liquidus temperature of the low melting point alloy before the thermally curable adhesive flux composition hardens. In some inventive adhesive compositions, multiple passes through a reflow oven may be needed to complete the sintering process.

The following examples are illustrative of preferred embodiments of the invention and are not to be construed as limiting the invention thereto. All percentages are given in weight percent, unless otherwise noted and equal a total of 100%.

### EXAMPLE 1:

### Inventive Die Attachment Composition

| Components | Amt | | wt % |
|---|---|---|---|
| mono-2-(methacryloyloxy)ethyl succinate | 0.65 | g | 1.69% |
| Hexahydrophthalic anhydride | 0.85 | g | 2.21% |
| Bisphenol A diglycidyl ether | 1.5 | g | 3.90% |
| 1,6-Hexanediol diacrylate | 0.26 | g | 0.68% |
| Azo biscyclohexanecarbontrile | 0.0011 | g | 0.003% |
| Silver Flake | 8.1 | g | 21.06% |
| Copper Powder | 9.5 | g | 24.70% |
| [symbol] | | | |

Hexahydrophthalic anhydride was dissolved in Bisphenol A diglycidyl ether by warming the mixture to 40-50° C. After stirring to form a homogeneous mixture, the blend was cooled to room temperature. mono-2-(Methacryloyloxy)ethyl succinate, 1,6-hexanediol diacrylate and azo biscyclohexanecarbontrile were then added with stirring to complete the polymer flux component of the adhesive composition. In a separate container, silver flake, copper powder and 58Bi42Sn solder powder were mixed, using a hand blender. This mixture of metal powders was then added to the polymer flux. Homogeneity was achieved by high shear mixing in a mechanical blender. Finally, the mixture was degassed under high vacuum.

The resultant paste was tested for viscosity on a Brookfield cone and plate viscometer and had a viscosity of about 111000 cps (@ 1 rpm, 2s-1). The composition was applied to a glass microscope slide and passed through a 5 minute solder reflow cycle having a peak temperature of 210° C., followed by a post cure at 165° C. for 30 minutes The resistance of the resultant metal coating was measured with an Ohmmeter, and used to calculate the volume resistivity 0.000051 Ohm-cm. Thermal conductivity of a sample similarly cured had a conductivity of: 16.5 W/ m K. A 5×5 mm silicon die with a nickel-gold metallization was attached to an immersion gold coated copper clad printed circuit with the adhesive and had voiding of <0.2% and a die shear strength 3200 psi. A sample of the material measured on a Perkin Elmer dynamic mechanical analyzer had a storage modulus of 9.8 Gpa and a coefficient of thermal expansion: 28-30 ppm/° C.

### EXAMPLE 2:

### Inventive Die Attachment Composition

| Components | Amt | | wt % |
|---|---|---|---|
| mono-2-(methacryloyloxy)ethyl succinate | 0.65 | g | 1.690% |
| Hexahydrophthalic anhydride | 0.85 | g | 2.210% |
| Bisphenol A diglycidyl ether | 1.5 | g | 3.900% |
| 1,6-Hexanediol diacrylate | 0.26 | g | 0.676% |
| Azo biscyclohexanecarbontrile | 0.0011 | g | 0.003% |
| Silver Flake | 9.7 | g | 25.220% |
| Copper Powder | 11.4 | g | 29.640% |
| 63Sn37Pb Solder Powder | 14.1 | g | 36.660% |

Hexahydrophthalic anhydride was dissolved in Bisphenol A diglycidyl ether by warming the mixture to 40-50° C. After stirring to form a homogeneous mixture, the blend was cooled to room temperature. mono-2-(Methacryloyloxy)ethyl succinate, 1,6-hexanediol diacrylate and azo biscyclohexanecarbontrile were then added with stirring to complete the polymer flux component of the adhesive composition. In a separate container, silver flake, copper powder and 63Sn37Pb solder powder were mixed, using a hand blender. This mixture of metal powders was then added to the polymer flux. Homogeneity was achieved by high shear mixing in a mechanical blender. Finally, the mixture was degassed under high vacuum.

The resultant paste was tested for viscosity on a Brookfield cone and plate viscometer and had a viscosity of about 238000 cps (@ 1 rpm, 2s-1). Thermal conductivity of a sample cured using a 5 minute solder reflow cycle having a peak temperature of 210° C., followed by a post cure at 190° C. for 30 minutes was measured to be: 16.4 W/ m K. A 5×5 mm silicon die with a nickel-gold metallization was attached to an immersion gold coated, copper clad printed circuit with the adhesive and had voiding of <0.2% and a die shear strength of 2800 psi.

The inventive subject matter being thus described, it will be obvious that the same may be varied in many ways. Such variations are not to be regarded as a departure from the spirit and scope of the inventive subject matter, and all such modifications are intended to be included within the scope of the following claims.

What is claimed is:

1. A thermally conductive adhesive composition devoid of fugitive solvents comprising:
a) a powder of a high melting point metal or metal alloy;
b) a powder of a low melting point metal or metal alloy; and
c) a thermally curable adhesive flux composition that is comprised of:
(i) a polymerizable fluxing agent represented by the formula RCOOH wherein R comprises a moiety having one or more polymerizable carbon-carbon double bonds; and
(ii) an inerting agent to react with the polymerizable fluxing agent at elevated temperature, rendering the polymerizable fluxing agent inert.

2. The thermally conductive adhesive composition according to claim 1 wherein the high melting point metal or metal alloy comprises a material selected from the group consisting of copper, silver, aluminum, nickel, gold, platinum, palladium, beryllium, rhodium, nickel, cobalt, iron, molybdenum and alloys and mixtures thereof.

3. The thermally conductive adhesive composition according to claim 1 wherein the low melting point metal or metal alloy comprises a material selected from the group consisting of Sn, Bi, Pb, Cd, Zn, In, Te, Tl, Sb, Se and alloys and mixtures thereof.

4. The thermally conductive adhesive composition according to claim 1 wherein the polymerizable fluxing agent comprises a material selected from the group consisting of 2-(methacryloyloxy)ethyl succinate, mono-2-(methacryloyloxy)ethyl maleate, mono-2-(methacryloyloxy)ethyl phthalate, mono-2-(acryloyloxy)ethyl succinate and mixtures thereof.

5. The thermally conductive adhesive composition according to claim 1 wherein the inerting agent comprises a material selected from the group consisting of bisphenol A diglycidyl ether, bisphenol F diglycidyl ether, 1,4-cyclohexanedimethanol diglycidyl ether, 3,4-epoxycyclohexylmethyl 3,4-epoxycyclohexaniecarboxylate, N,N-diglycidyl-4-glycidyl-oxyaniline, glycidyl phenyl ether, glycidyl 4-methoxyphenyl ether, epoxy propyl benzene and mixtures thereof.

6. The thermally conductive adhesive composition according to claim 1 further comprising one or more components selected from the groups consisting of:
(i) a diluent that is capable of polymerizing with the fluxing agent's polymerizable carbon-carbon double bonds;
(ii) a source of free radical initiators;
(iii) a curable resin;
(iv) a crosslinking agent that improves crosslinking of the curable resins or fluxing agents; and
(v) an accelerator to increase the rate of reaction.

7. The thermally conductive adhesive composition according to claim 6 wherein said diluent comprises a material selected from the group consisting of 1,6-hexanediol diacrylate, 1,6-hexanediol dimethacrylate, tris[2-(acryloxy)ethyl]isocyanurate, trimethylolpropane trimethacrylate, ethoxylated bisphenol diacrylate and mixtures thereof

8. The thermally conductive adhesive composition according to claim 6 wherein said sourse of free radical initiators comprises a material selected from the group consisting of benzoyl peroxide, cumyl peroxide, 1,1′-azobis(cyclohexanecarbonitrile), 2,2′-azbbisisobutyronitrile, and mixtures thereof.

9. The thermally conductive adhesive composition according to claim 6 wherein said curable resin comprises a material selected from the group consisting of epoxies, phenolics, phenolic novalacs, cresolic novalacs, polyurethanes, polyimides, bismaleimides, maleimides, cyanate esters, polyvinyl alcohols, polyesters, and polyureas.

10. The thermally conductive adhesive composition according to claim 6 wherein said crosslinking agent comprises a material selected from the group consisting of tetrahydrophthalic anhydride, hexahydro phthalic anhydride, nadic methyl anhydride, 4- methylhexahydrophthalic anhydride, methyltetrahydrophthalic anhydride and mixtures thereof.

11. The thermally conductive adhesive composition according to claim 6 wherein said accelerator comprises a material selected from the group consisting of imidazole and its derivatives, dicyandiamide, biguanide derivatives, tertiary amines, transition metal acetylacetonates, and mixtures thereof.

12. An electronic assembly comprising an electronic device and a substrate bonded by a sintered thermally conductive adhesive, said adhesive devoid of fugitive solvents and comprising:
a) a powder of a high melting point metal or metal alloy;
b) a powder of a low melting point metal or metal alloy; and
c) a thermally curable adhesive flux composition that is comprised of:
(i) a polymerizable fluxing agent;
(ii) an inerting agent to react with the fluxing agent at elevated temperature, rendering the polymerizable fluxing agent inert.

13. The electronic assembly according to claim 12 wherein the thermally curable adhesive flux composition further comprises a polymerizable fluxing agent represented by the formula RCOOH wherein R comprises a moiety having one or more polymerizable carbon-carbon double bonds.

14. The electronic assembly composition according to claim 12 wherein the polymerizable fluxing agent comprises a material selected from the group consisting of 2-(methacryloyloxy)ethyl succinate, mono-2 -(methacryloyloxy)ethyl maleate, mono-2-(methacryloyloxy)ethyl phthalate, mono-2-acryloyloxy)ethyl succinate and mixtures thereof.

15. The electronic assembly composition according to claim 12 wherein the high melting point metal or metal alloy comprises a material selected from the group consisting of copper, silver, aluminum, nickel, gold, platinum, palladium, beryllium, rhodium, nickel, cobalt, iron, molybdenum and alloys and mixtures thereof.

16. The electronic assembly according to claim 12 wherein the low melting point metal or metal alloy comprises a material selected from the group consisting of Sn, Bi, Pb, Cd, Zn, In, Te, Tl, Sb, Se and alloys and mixtures thereof.

17. The electronic assembly according to claim 12 wherein the inerting agent comprises a material selected from the group consisting of bisphenol A diglycidyl ether, bisphenol F diglycidyl ether, 1,4-cyclohexanedimethanol diglycidyl ether, 3,4-epoxycyclohexylmethyl 3,4-epoxycyclohexanecarboxylate, N,N-diglycidyl-4-glycidyl-oxyaniline, glycidyl phenyl ether, glycidyl4-methoxyphenyl ether, epoxy propyl benzene and mixtures thereof.

18. A method of attaching an electronic device to a substrate comprising the steps of:
(a) obtaining an electronic device with at least one bondable surface;
(b) obtaining a substrate with a corresponding bondable surface;
(c) dispensing a thermally conductive adhesive on one or both of the bondable surfaces of the substrate or electronic device, said adhesive devoid of fugitive solvents and comprising
(i) a powder of a high melting point metal or metal alloy;
(ii) a powder of a low melting point metal or metal alloy; and
(iii) a thermally curable adhesive flux composition that is comprised of:
(A) a polymerizable fluxing agent;
(B) an inerting agent to react with the fluxing agent at elevated temperature, rendering the polymerizable fluxing agent inert.
(d) placing the electronic device on the substrate so the bondable surface of the electronic device is mated with the bonding surface of the substrate, thereby forming a combined assembly;
(e) heating the combined assembly to an elevated temperature, thereby causing the powder of the low melting point metal or metal alloy to liquefy;
(f) allowing the liquefied low melting point metal or metal alloy to sinter with the high melting point metal or metal alloy and the inerting agent to react with the fluxing agent, rendering the fluxing agent inert;
(g) polymerizing the fluxing agent; and
(h) allowing the assembly to cool.

19. The method according to claim 18 wherein the thermally curable adhesive flux composition further comprises a polymerizable fluxing agent represented by the formula RCOOH wherein R comprises a moiety having one or more polymerizable carbon-carbon double bonds.

20. The method according to claim 18 wherein the polymizerable fluxing agent comprises a material selected from the group consisting of 2-(methacryloyloxy)ethyl succinate, mono-2-(methacryloyloxy)ethyl maleate, mono-2-(methacryloyloxy)ethyl phthalate, mono-2-(acryloyloxy)ethyl succinate and mixtures thereof.

21. The method according to claim 18 wherein the high melting point metal or metal alloy comprises a material selected from the group consisting of copper, silver, aluminum, nickel, gold, platinum, palladium, beryllium, rhodium, nickel, cobalt, iron, molybdenum and alloys and mixtures thereof.

22. The method according to claim 18 wherein the low melting point metal or metal alloy comprises a material selected from the group consisting of Sn, Bi, Pb, Cd, Zn, In, Te, Tl, Sb, Se and alloys and mixtures thereof.

23. The method according to claim 18 wherein the inerting agent comprises a material selected from the group consisting of bisphenol A diglycidyl ether, bisphenol F diglycidyl ether, 1,4-cyclohexanedimethanol diglycidyl ether, 3,4-epoxycyclohexylmethyl 3,4-epoxycyclohexanecarboxylate, N,N-diglycidyl-4-glycidyl-oxyaniline, glycidyl phenyl ether, glycidyl 4-methoxyphenyl ether, epoxy propyl benzene and mixtures thereof.
